(19) United States
(12) Patent Application Publication
(10) Pub. No.: US 2009/0085763 A1
(43) Pub. Date: Apr. 2, 2009

(54) INFORMATION PROCESSING APPARATUS

(75) Inventor: Shojiro SATO, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/194,251

(22) Filed: Aug. 19, 2008

(30) Foreign Application Priority Data
Sep. 28, 2007 (JP) 2007-255031

(51) Int. Cl. G06F 13/42

(52) U.S. Cl. 340/825; 710/107

(57) ABSTRACT

According to one embodiment, a HDMI interface receives a first control signal transmitted from an external device. A control signal information storage processing unit stores reception time information of the first control signal into a storage unit. An acceptance suspension period setting unit suspends acceptance of a second control signal generated in accordance with a user operation, for a predetermined period from a time corresponding to the reception time information stored in the storage unit.

### CROSS-REFERENCE TO RELATED APPLICATIONS

This application is based upon and claims the benefit of priority from Japanese Patent Application No. 2007-255031, filed Sep. 28, 2007, the entire contents of which are incorporated herein by reference.

### BACKGROUND

1. Field

One embodiment of the invention relates to an information processing apparatus having HDMI-CEC connection mode.

2. Description of the Related Art

In recent years, a method has come to be known in which plural information processing apparatuses such as audio visual (AV) devices are connected in High-Definition Multimedia Interface (HDMI)-Consumer Electronics Control (CEC) mode to mutually control the plural AV devices. HDMI-CEC is a control function for mutually controlling the AV devices connected in HDMI-CEC mode in accordance with a control protocol and a device control signal standardized by HDMI.

Plural (two) AV devices are connected to each other in HDMI-CEC mode, and in the case under consideration, that two AV devices are a TV receiver and a Digital Versatile Disk (DVD) reproduction device. Also, assume that the user performs the operation for switching on power for the TV receiver by pushing a power button of a remote controller. Since the TV receiver and the DVD reproduction device are connected in HDMI-CEC mode, a power signal (power supply starting signal) providing a control signal for switching on the DVD reproduction device is transmitted from the TV receiver to the DVD reproduction device, so that the user can switch on the DVD reproduction device by operating the TV receiver.

Also, in the case where the user requests the TV receiver for the operation (for example, play, stop, rapid feed, rewind, etc.) of the DVD reproduction device, a control signal is transmitted from the TV receiver to the DVD reproduction device to execute the requested operation. As a result, the user can operate the DVD reproduction device by operating the TV receiver.

In the plural AV devices (the TV receiver and the DVD reproduction device in the case under consideration) connected in HDMI-CEC mode as described above, the control signal transmitted from the TV receiver to the DVD reproduction device and the control signal generated by operating the remote controller of the DVD reproduction device or the DVD reproduction device itself may be received substantially at the same time by the DVD reproduction device. In such a case, the DVD reproduction device may operate in a way unexpected to the user.

Specifically, assume, for example, that the user switches on the TV receiver when the TV receiver is in standby state. In this case, the control signal (power signal) is transmitted to the DVD reproduction device (device connected to the TV receiver in CEC mode) through the TV receiver starting process. Then, the starting process is executed in the DVD reproduction device. In the case where another user (or the same user) switches on the DVD reproduction device by operating the remote controller of the DVD reproduction device or the DVD reproduction device itself during the starting process period of the DVD reproduction device, the DVD reproduction device receives the power signal twice with a small time difference. As a result, the DVD reproduction device returns to the standby state immediately after being switched on.

In view of this, a technique has been disclosed to prevent the malfunction of each electronic device making up a system even in the case where double signals are input thereto (see, for example, Jpn. Pat. Appln. KOKAI Publication No. 7-250386). According to this prior art, in the case where a signal is received through a bus before the lapse of a predetermined reference time, the signal received through the bus is identical with (or of the same type as) the remote control signal received directly, then the signal received through the bus is substantially ignored thereby to prevent the malfunction of the electronic device.

As described above, according to the prior art, in the case where the double control signals generated are identical with (or of the same type as) each other, one of them is ignored, i.e., not accepted thereby to prevent the malfunction.

In the prior art described above, however, although the malfunction due to the double control signals which may be generated can be prevented by ignoring, i.e., rejecting to accept the control signal generated by the operation of the remote controller of the DVD reproduction device, the user who has performed the operation cannot recognize the non-acceptance of his/her operation in view of the fact that the double control signals are transmitted from the DVD reproduction device and the TV receiver connected to the DVD reproduction device in HDMI-CEC mode.

According to the prior art, in the case where the double control signals are generated for the DVD reproduction device from the TV receiver and the DVD reproduction device, both control signals may be accepted. Assume, for example, that the control signal transmitted from the TV receiver to the DVD reproduction device and the control signal generated by the operation of the remote controller of the DVD reproduction device are received at substantially the same time by the DVD reproduction device and that these control signals are not identical with each other. In this case, according to the prior art, the process corresponding to both control signals is executed in the DVD reproduction device.

A specific example is a case in which both the TV receiver and the DVD reproduction device are in operation and the control signal transmitted from the TV receiver to the DVD reproduction device by the user operation is for “fast forward”, while the control signal generated by the operation of the remote controller of the DVD reproduction device is for “rewind”.

In such a case, the double control signals, being not identical with each other, are both executed in the conventional technique. As a result, the DVD reproduction device may suddenly switch from fast forward mode to rewind mode or in the other way around, for example, against the intention of the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the hardware configuration of a DVD reproduction device 10 according to an embodiment of the invention.

FIG. 2 is an exemplary flowchart showing the processing procedure of the DVD reproduction device 10 in the embodiment.

FIG. 3 is an exemplary diagram showing a layout of plural AV devices including the DVD reproduction device 10 in the embodiment.

FIG. 4 is an exemplary diagram showing the time flow when the double signals including a control signal A and a control signal B are received in the DVD reproduction device 10 in the embodiment.

### DETAILED DESCRIPTION

Various embodiments according to the invention will be described hereinafter with reference to the accompanying drawings. In general, according to one embodiment of the invention, an information processing apparatus comprising: a reception unit which receives a first control signal transmitted from an external source; a storage unit which stores a reception time at which the first control signal is received; and an acceptance suspension unit which suspends acceptance of a second control signal generated in accordance with a user operation, for a predetermined period from the reception time stored in the storage unit.

An embodiment of the invention will be explained below with reference to the accompanying drawings.

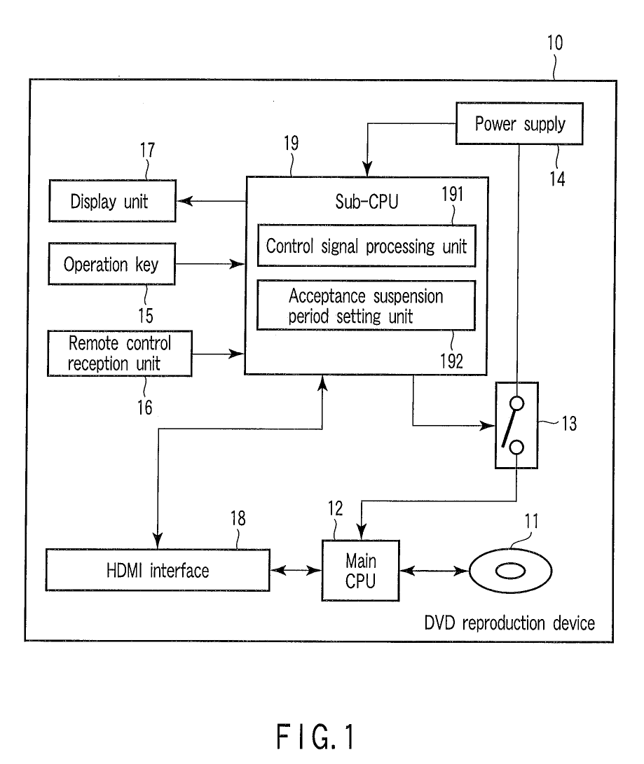

FIG. 1 is a block diagram showing the hardware configuration of an information processing apparatus according to an embodiment of the invention. In the following description, the information processing apparatus will be explained as an Audio Visual (AV) device. In FIG. 1, the hardware configuration of a Digital Versatile Disk (DVD) reproduction device 10 is shown as an example of the AV device. The AV device according to this embodiment may alternatively be an AV amplifier or a TV receiver.

As shown in FIG. 1, the DVD player or reproduction device 10 includes a disk 11 such as a DVD, a main processor (hereinafter referred to as the main CPU) 12, a power management unit 13, a power supply 14, a operation key 15, a remote control reception unit 16, a display unit 17, a HDMI interface 18 and a subprocessor (hereinafter referred to as the sub-CPU) 19.

The DVD reproduction device 10 shown in FIG. 1 is a device for reproducing the video data, etc., stored (memorized) in the disk 11 and is connected to another AV device (another information processing apparatus) such as a TV receiver in High-Definition Multimedia Interface (HDMI)-Consumer Electronics Control (CEC) mode. Plural AV devices (such as the DVD reproduction device 10 and the TV receiver), if connected to each other in HDMI-CEC mode (hereinafter sometimes referred to simply as “CEC mode”), can be controlled bidirectionally even in the case where they are arranged in different rooms.

Also, the DVD reproduction device 10, by adding the information indicating the transition of the operation mode thereof to the information sent through the AV link of HDMI, has the function of notifying the transition of the operation mode of the DVD reproduction device 10 to the user of other AV devices connected to the DVD reproduction device 10 in CEC mode (hereinafter referred to as the operation mode notification function).

The main CPU 12 executes the reproduction process of the DVD reproduction device 10. The main CPU 12 also controls the AV connection in the HDMI interface 18. The power management unit 13 is arranged between the main CPU 12 and the power supply 14 to execute the process of supplying power to each block such as the main CPU 12.

The operation key 15 is operated by the user of the DVD reproduction device 10, for example, to generate the control signal for the DVD reproduction device 10. Also, the remote control reception unit 16 receives the control signal transmitted from a remote controller (not shown) operated by the user. These control signals cause the DVD reproduction device 10 to execute the processes of power on, play, stop, fast forward or rewind.

The display unit 17 displays the operation mode of the DVD reproduction device 10 based on the control signal generated by the operation of the operation key 15 or the remote controller.

The HDMI interface 18 receives or inputs the control signal transmitted thereto from another AV device with the CEC function connected to the DVD reproduction device 10 in CEC mode. This control signal is transmitted to the DVD reproduction device 10 by the user operation, for example, of the device with the CEC function, for example, the TV receiver.

The sub-CPU 19 has a path for reading, for example, the control signal generated by the operation of the operation key 15 and a path for reading the control signal received by the remote control reception unit 16. Also, the sub-CPU 19 has a path for executing the CEC control operation in the HDMI interface 18.

The sub-CPU 19 accepts or receives the control signal or command for power on/off, play, stop, etc., generated by the user operation of the operation key 15. Also, the sub-CPU 19 accepts, through the remote control reception unit 16, the control signal generated by the user operation of the remote controller. Further, the sub-CPU 19 accepts the control signal received by the HDMI interface 18. Based on the control signals thus accepted, the sub-CPU 19 executes various processes in the DVD reproduction device 10.

In the case where the power supply (receptacle) 14 of the DVD reproduction device 10 is inserted, for example, power is supplied to the sub-CPU 19 and the DVD reproduction device 10 enters the standby mode. In the case where the DVD reproduction device 10 enters the standby mode, the sub-CPU 19 can accept the control signals for switching on/off the power supply, closing/opening the DVD tray, etc. In the case where the user operates the operation key 15 or the remote controller to select the starting of the DVD reproduction device 10, the sub-CPU 19 controls the power management unit 13, for example, and supplies power to the whole DVD reproduction device 10. In the DVD reproduction device 10, therefore, the reproduction process of a DVD, for example, is made possible.

The sub-CPU 19 includes a control signal processing unit 191 and an acceptance suspension period setting unit 192. The control signal processing unit 191 and the acceptance suspension period setting unit 192 are realized by the sub-CPU 19 executing a program stored in a storage unit such as a ROM (not shown).

The control signal processing unit 191 executes the process of storing, in a storage unit (not shown), for example, a reception time at which the control signal (first control signal) transmitted from an AV device (for example, TV receiver) connected in CEC mode with the DVD reproduction device 10 is received by the HDMI interface 18. Also, the control signal processing unit 191 executes the process of storing a history (reception history) of, for example, the control signals generated by the operation of the operation key 15 or the control signals received by the remote control reception unit 16 during the acceptance suspension period (described later).

In the acceptance suspension period setting unit 192, on the other hand, a predetermined period from the reception time stored by the control signal processing unit 191 is set as a period (acceptance suspension period) during which the control signal generated by the operation of the operation key 15 or the control signal received by the remote control reception unit 16 is not accepted. Also, the acceptance suspension period setting unit 192 changes the acceptance suspension period in accordance with the control signal transmitted thereto from an AV device connected in CEC mode with, for example, the DVD reproduction device 10. Also, the acceptance suspension period setting unit 192 changes the acceptance suspension period to a period designated by the user of, for example, the DVD reproduction device 10.

In the acceptance suspension period setting unit 192, the acceptance of the control signal (second control signal) generated by the operation of the operation key 15 or the control signal (second control signal) received by the remote control reception unit 16 is suspended during the acceptance suspension period starting from the reception time stored by the control signal processing unit 191.

Also, upon generation of a control signal (the control signal generated by the operation of the operation key 15 or the control signal received by the remote control reception unit 16) during the acceptance suspension period, the acceptance suspension period setting unit 192 displays a notice that the control signal is not accepted (the acceptance is suspended) on the display unit 17. As a result, the user of the DVD reproduction device 10 is notified that the control signal cannot be accepted.

Further, the acceptance suspension period setting unit 192 transmits the stored reception history of the control signal generated during the acceptance suspension period to another AV device connected in CEC mode with the DVD reproduction device 10 through the HDMI interface 18. In the process, the acceptance suspension period setting unit 192 utilizes an operation mode notification function of the DVD reproduction device 10 described above. As a result, the acceptance suspension period setting unit 192 displays the reception history on the other AV device connected in HDMI-CEC mode with the DVD reproduction device 10.

In this way, the control signals generated during the acceptance suspension period (i.e., the operation of the operation key 15 or the remote controller of the DVD reproduction device 10) are notified to the user of the other AV device connected in CEC mode with the DVD reproduction device 10.

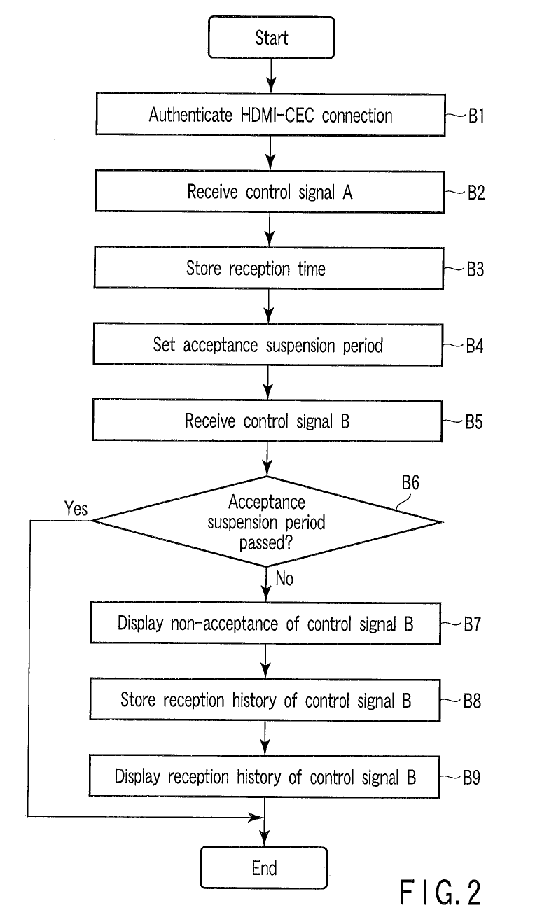

Next, with reference to the flowchart of FIG. 2, the processing procedure executed by the DVD reproduction device 10 shown in FIG. 1 will be explained. Incidentally, as described above, the DVD reproduction device 10 is assumed to be connected in CEC mode with another AV device. The description that follows assumes that the other AV device connected in CEC mode with the DVD reproduction device 10 is the TV receiver.

First, the connection in HDMI-CEC mode between the DVD reproduction device 10 and the TV receiver is authenticated (block B1), so that the bidirectional control operation is made possible, for example, between the DVD reproduction device 10 and the TV receiver.

Next, the HDMI interface 18 included in the DVD reproduction device 10 receives (inputs) a first control signal (hereinafter referred to as a control signal A) for the DVD reproduction device 10 generated by the operation of the TV receiver by the user thereof (block B2). Upon receipt of the control signal A, the DVD reproduction device 10 executes the control process (for example, the process of switching on power) based on the control signal A.

The control signal processing unit 191 executes the process of storing the reception time at which the control signal A is received by the HDMI interface 18 (block B3). Incidentally, the control signal processing unit 191 is realized by the process in which the sub-CPU 19 included in the DVD reproduction device 10 executes a program stored, for example, in the ROM.

Also, the acceptance suspension period setting unit 192 sets (changes) the acceptance suspension period in accordance with the control signal A received by the HDMI interface 18 (block B4).

Assume, for example, that the control signal A transmitted from the TV receiver connected in CEC mode with the DVD reproduction device 10 is a power signal for controlling the operation of switching on the power supply. Also, assume that the DVD reproduction device 10 is in standby mode. In this case, assume that the DVD reproduction device 10 receives the control signal A (power signal) and the time to transfer from the standby mode to the operation mode (transition time) in accordance with the received control signal A is 15 seconds. Also, assume that a predetermined acceptance suspension period is not longer than 15 seconds (for example, 10 seconds). In this case, for example, the DVD reproduction device 10, in spite of the operation mode notification function thereof described above, cannot notify the transition of the operation mode due to a control signal, if generated, by the operation of the operation key 15 or the remote controller of the DVD reproduction device 10 after the lapse of the acceptance suspension period before the end of the transition time. In the case where the transition time of the control signal (power signal) is 15 seconds, therefore, the acceptance suspension period is changed to longer than the transition time (for example, 20 seconds). Also, in the case where the control signal A is a “reproduction suspension” signal, it may indicate the intention of the user of the TV receiver to leave his/her place temporarily or answer a phone call. In order to prevent the cancellation of the reproduction suspension state by the operation of the remote controller or the operation key 15 of the DVD reproduction device 10, the acceptance suspension period is changed to, for example, one minute. In this way, the acceptance suspension period is changed in accordance with the control signal A (or the time required to execute the process based on the control signal A).

In the case where the transition time of the control signal A is shorter than the predetermined acceptance suspension period (for example, 10 seconds), the acceptance suspension period is not changed.

The acceptance suspension period setting unit 192, like the control signal processing unit 191, is realized by the process in which the sub-CPU 19 included in the DVD reproduction device 10 as described above executes a program stored in the ROM.

Next, the sub-CPU 19 receives (inputs) a second control signal (hereinafter referred to as a control signal B) generated, for example, by the user operation of the operation key 15 (or by the user operation of the remote controller) (block B5). Incidentally, the control signal B generated by the operation of the remote controller is received by the remote control reception unit 16.

The acceptance suspension period setting unit 192 decides whether the time at which the control signal B is received has elapsed the acceptance suspension period from the reception time (the time at which the control signal A is received) stored by the control signal processing unit 191 (block B6).

Upon decision that the acceptance suspension period has not elapsed (NO in block B6), i.e., upon receipt of the control signal B during the acceptance suspension period, the acceptance of the control signal B is suspended. In the DVD reproduction device 10, therefore, the control process based on the control signal B thus received is not executed.

The acceptance suspension period setting unit 192 displays, through the display unit 17, the notice that the received control signal B is not accepted (block B7). As a result, the non-acceptance of the control signal B is notified to the user of, for example, the DVD reproduction device 10.

The control signal processing unit 191 executes the process of storing the reception history of the control signal B received during the acceptance suspension period (block B8). Incidentally, plural control signals B, if received during the acceptance suspension period, are stored in chronological order as the reception history.

In the acceptance suspension period setting unit 192, the reception history (i.e., the contents of the operation of the DVD reproduction device 10 during the acceptance suspension period) stored by the control signal processing unit 191 is transmitted to the TV receiver through the HDMI interface 18 after the lapse of the acceptance suspension period. As a result, the operation of the control signal B generated during the acceptance suspension period is displayed on the TV receiver, for example, and thus notified to the user of the TV receiver (Block B9). Plural control signals B, if generated during the acceptance suspension period, are displayed on the TV receiver in chronological order as the history of receiving them.

Upon decision in block B6 that the acceptance suspension period has elapsed, on the other hand, the DVD reproduction device 10 accepts the received control signal B. As a result, the control process based on the control signal B is executed.

Although the foregoing description assumes that the acceptance suspension period is automatically changed by the acceptance suspension period setting unit 192 in accordance with the control signal A in block B4, the acceptance suspension period may alternatively be changed to the period designated by the user in accordance with the user operation of, for example, the DVD reproduction device 10.

Also, in spite of the description above that the reception history is displayed after the lapse of the acceptance suspension period in block B9, the user of the TV receiver may alternatively be notified each time control signal B is received.

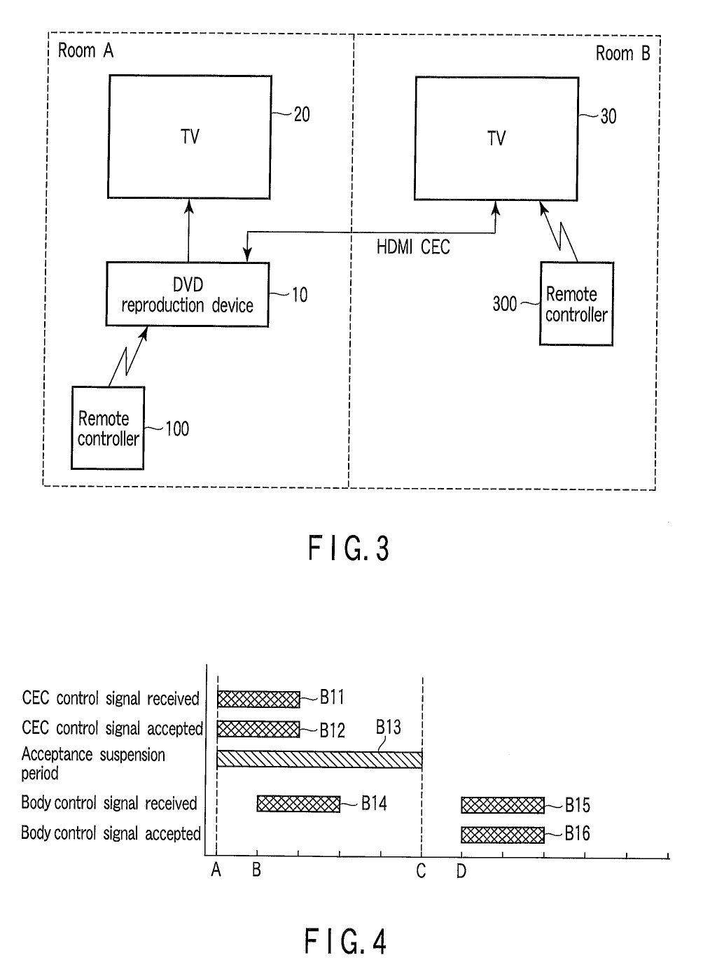

Next, with reference to FIGS. 3 and 4, the operation of the DVD reproduction device 10 according to this embodiment will be explained specifically.

FIG. 3 shows an example of the layout of plural AV devices including the DVD reproduction device 10 which may be used. As shown in FIG. 3, the DVD reproduction device 10 is assumed to be arranged in a room A. This DVD reproduction device 10 can be operated by using, for example, a remote controller 100. The DVD reproduction device 10 is connected to a TV receiver (AV device) 20 arranged in the room A in analog AV mode.

Also, the DVD reproduction device 10 is connected in CEC mode to a TV receiver (AV device) 30 arranged in a room B different from the room A. As a result, the user of the TV receiver 30, by operating the TV receiver 30, can operate (control) the DVD reproduction device 10 arranged in the room A without taking the trouble to enter the room A.

The TV receiver 30 can be operated using, for example, a remote controller 300. Incidentally, the TV receiver 30 has a last memory function. According to this function, at the time of transition (hereinafter referred to as the first state transition) of the TV receiver 30 from the operation mode to the standby mode by the user operation of the remote controller 300, for example, the input path selected for the operation mode is stored in a last memory (not shown). The stored input path is selected at the time of the next transition from the standby mode to the operation mode (hereinafter referred to as the second state transition). Assume, for example, that the user watches, through the TV receiver 30, an image reproduced by the DVD reproduction device 10 at the time of the first state transition. In this case, also assume that after the DVD reproduction device 10 enters the standby mode due to the first state transition, the TV receiver 30 is started, for example, by the user operation of the remote controller 300 (second state transition). Then, the power signal (control signal) is sent from the TV receiver 30 to the DVD reproduction device 10 by the last memory function, and therefore, the operation mode for the first state transition is activated.

Even in the case where the power signal is sent to the DVD reproduction device 10 from the TV receiver 30 as described above, the user of the TV receiver 30 may not know whether the last memory function is effective or not (i.e., whether the power signal is sent from the TV receiver 30 to the DVD reproduction device 10). In this case, the user of the TV receiver 30 may move from room B with the TV receiver 30 arranged therein to room A with the DVD reproduction device 10 arranged therein and switch on power by operating the operation key 15 (or the remote controller 100) of the DVD reproduction device 10. Even in the case where the power signal is sent from the TV receiver 30 to the DVD reproduction device 10, a different user not informed of the fact may perform the operation to start the DVD reproduction device 10 using the TV receiver 20 connected in analog fashion. In such a case, double power signals are received by the DVD reproduction device 10.

FIG. 4 shows the flow of time in the case where the power signal (control signal A) transmitted from the TV receiver 30 started by the user operation of the remote controller 300 and the control signal (control signal B) generated by the operation of the operation key 15 (or the remote controller 100) of the DVD reproduction device 10 may be received as double signals in the DVD reproduction device 10.

In the example of FIG. 4, assume that the DVD reproduction device 10 receives, at time A, the control signal A (CEC control signal) transmitted from, for example, the TV receiver 30 (block B11).

In the process, the DVD reproduction device 10 accepts the control signal A thus received (block B12). As a result, the DVD reproduction device 10 executes the control process (for example, the starting process) based on the control signal A thus accepted.

In the DVD reproduction device 10, the reception time (time A) at which the control signal A is received is stored. Once the time A at which the control signal A is received is stored in the DVD reproduction device 10, the acceptance suspension period is set (changed), for example, based on the control signal A (block B13). In the process, the predetermined acceptance suspension period (for example, 10 seconds) is changed to 20 seconds, for example, in the case where the type of the control signal A received in the DVD reproduction device 10 is the power signal. In the example shown in FIG. 4, the time from A to time C is assumed to represent the acceptance suspension period (20 seconds).

Next, assume that the DVD reproduction device 10 receives the control signal B (body control signal) generated by the user operation of the operation key 15 (or the remote controller 100) of the DVD reproduction device 10, for example, at time B (block B14).

The time B at which the control signal B is received is yet to pass the acceptance suspension period (i.e., the time C) set in the block B13. In other words, the control signal B is received during the acceptance suspension period. In this case, the control signal B is not accepted by the DVD reproduction device 10 (the acceptance of the control signal B is suspended). As a result, the control process based on the control signal B is not executed in the DVD reproduction device 10.

The control signal A and the control signal B are not necessarily identical (in type) with each other. Specifically, in the case where both the control signal A and the control signal B are power signals (i.e., in the case where the control signal A and the control signal B are identical with each other) and the time at which the control signal B is received is included in the acceptance suspension period, then the control signal B is not accepted by the DVD reproduction device 10. In the case where the control signal A is the fast forward signal and the control signal B the rewind signal (i.e., in the case where the control signal A and the control B are different from each other), on the other hand, the control signal B is not accepted by the DVD reproduction device 10 as long as the time at which the control signal B is received during the acceptance suspension period.

Also, in the case where the control signal B is received during the acceptance suspension period in the DVD reproduction device 10, for example, the non-acceptance of the control signal B is displayed on the display unit 17 of the DVD reproduction device 10. Then, the non-acceptance of the control signal B is notified to the user of the DVD reproduction device 10.

In the case where the control signal B is not accepted by the DVD reproduction device 10, the reception history of the control signal B is stored, and after the lapse of the acceptance suspension period, for example, displayed on the TV receiver 30 utilizing the operation mode notification function of the DVD reproduction device 10. As a result, the operation of the operation key 15 (or the remote controller 100) (i.e., the control signal B) of the DVD reproduction device 10 during the acceptance suspension period is notified to the user of the TV receiver 30.

In the DVD reproduction device 10, on the other hand, assume that the control signal B generated by the user operation of the operation key 15 (or the remote controller 100) of the DVD reproduction device 10 is received, for example, at time D (block B15).

The time D at which the control signal B is received has passed the acceptance suspension period (i.e., the time C). In this case, the DVD reproduction device 10 accepts the control signal B (block 16). Thus, the control process based on the control signal B is executed in the DVD reproduction device 10.

As described above, according to this embodiment, during the predetermined acceptance suspension period from the time of the start of the control operation by the TV receiver 30 connected in CEC mode (i.e., from the time when the control signal A transmitted from the TV receiver 30 is received), the acceptance of the control signal B generated by the operation of the operation key 15 (or the remote controller 100) of the DVD reproduction device 10, for example, is suspended. Specifically, in the case where the acceptance suspension period is 10 seconds, for example, the acceptance of the control signal B is suspended for at least 10 seconds from the time when the control signal A is received. Even in the case where double control signals are generated for the DVD reproduction device 10, therefore, the malfunction can be prevented.

Also, according to this embodiment, upon receipt of the control signal B by the DVD reproduction device 10 during the acceptance suspension period, the non-acceptance of the control signal B is notified to the user of the DVD reproduction device 10. The user of the DVD reproduction device 10, therefore, can confirm that the control signal A is generated from the TV receiver 30 connected in CEC mode with the DVD reproduction device 10, and the operation of the operation key 15 (or the remote controller 100) of the DVD reproduction device 10 without knowing that the control signal B is not accepted can be avoided.

Also, according to this embodiment, the acceptance suspension period can be changed based on the control signal A (or the type of the control signal A) transmitted from the TV receiver 30 connected in CEC mode with the DVD reproduction device 10. This makes it possible to effectively utilize the function (the operation mode notification function) of notifying the transition of the operation mode of the DVD reproduction device 10, for example, to the user of the TV receiver 30.

Also, according to this embodiment, the user of the DVD reproduction device 10, for example, can designate the acceptance suspension period. As a result, in the case where the transition time of the operation mode from the standby mode based on the power signal is as long as 30 seconds, for example, the user can change the acceptance suspension period in accordance with the prevailing situation by designating 40 seconds, for example, as the acceptance suspension period in the DVD reproduction device 10.

Also, according to this embodiment, assuming that the control signal B generated by the operation of the operation key 15 (or the remote controller 100) of the DVD reproduction device 10 is received by the DVD reproduction device 10 during the acceptance suspension period, the operation is notified to the user of the TV receiver 30 by displaying the control signal B (the operation of the DVD reproduction device 10 during the acceptance suspension period) on the TV receiver 30. As a result, the user of the TV receiver 30 can confirm the control signal B (the operation) received during the acceptance suspension period. As a result, the user of the TV receiver 30 can execute again the contents of the operation notified as required. Specifically, user of the TV receiver 30 connected in CEC mode may not be fully informed of all the CEC control functions. The function (picture in picture) of reproducing two types of content items and containing one content item in the other content, item for example, is not included in the CEC control standard. This operation, if performed during the acceptance suspension period, for example, is notified to the user, and therefore, the user can perform the operation again. Also, the operations performed during the acceptance suspension period are displayed in chronological order, for example, so that the user can grasp the operation performed immediately before the end of the acceptance suspension period, for example, and therefore, can be informed which operation leads to the operation intended by him/her.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An information processing apparatus comprising:
a reception unit which receives a first control signal transmitted from an external device;
a storage unit which stores reception time information of the first control signal; and
an acceptance suspension unit which suspends acceptance of a second control signal generated in accordance with a user operation, for a predetermined period from a time corresponding to the reception time information stored in the storage unit.

2. The information processing apparatus according to claim 1, further comprising:
a notification unit which notifies that the acceptance suspension unit suspends acceptance of the second control signal.

3. The information processing apparatus according to claim 1, further comprising:
a change unit which changes the predetermined period in accordance with the first control signal received.

4. The information processing apparatus according to claim 1, further comprising:
a change unit which changes the predetermined period to a period designated by the user.

5. The information processing apparatus according to claim 1, wherein
the first control signal is transmitted from another information processing apparatus, and
the acceptance suspension unit displays, on the other information processing apparatus, the second control signal of which the acceptance is suspended.

6. A method (suspending acceptance of a control signal) performed by a information apparatus comprising a storage unit, comprising:
receiving a first control signal transmitted from an external device;
storing reception time information of the first control signal into the storage unit;
suspending acceptance of a second control signal generated in accordance with a user operation, for a predetermined period from a time corresponding to the reception time information stored in the storage unit.

7. The method according to claim 6, further comprising:
notifying the suspension of the acceptance of the second control signal.

8. The method according to claim 6, further comprising:
changing the a predetermined period in accordance with the first control signal received.

9. The method according to claim 6, further comprising:
changing the predetermined period to a period designated by the user.

10. The method according to claim 6, further comprising:
displaying the second control signal of which the acceptance is suspended on another information processing apparatus which transmits the first control signal.
